(19) United States
(12) Patent Application Publication
(10) Pub. No.: US 2011/0224329 A1
(43) Pub. Date: Sep. 15, 2011

(54) METAL STABILIZERS FOR EPOXY RESINS AND DISPERSION PROCESS

(75) Inventors: Frank Y. Gong, Shanghai (CN); Michael J. Mullins, Houston, TX (US); Raymond J. Thibault, Shrewsbury, MA (US); Wayne Yi, Shanghai (CN)

(73) Assignee: Dow Global Technologies LLC, Midland, MI (US)

(21) Appl. No.: 13/127,837

(22) PCT Filed: Jan. 6, 2009
(86) PCT No.: PCT/CN09/00016

§ 371 Date: May 5, 2011

(51) Int. Cl. C09D 163/02; C09J 163/02; C09D 161/16; C08K 3/22; C08K 5/56; C09J 161/16

(52) U.S. Cl. 523/435; 523/400; 524/592; 523/459; 523/454; 524/435

(57) ABSTRACT

A method comprising (a) mixing a stabilizer comprising a metal-containing compound, the metal-containing compound comprising a metal selected from the group consisting of Group 11-13 metals and combinations thereof, into a dispersant to provide a dispersion; and (b) adding the dispersion to a varnish, is disclosed.

### FIELD OF THE INVENTION

Embodiments disclosed herein relate to dispersions. More specifically, embodiments disclosed herein relate to dispersions used in varnishes containing epoxy resins.

### BACKGROUND OF THE INVENTION

With recently-enacted legislation mandating lead-free solders, temperatures at which printed circuit boards (PCBs) are exposed has increased to ˜260° C. At these temperatures the inherent thermal stability of current brominated epoxy resin-dicyandiamide (DICY) cure technology have been exceeded except for simple boards for which some failure is acceptable. This increased temperature translates to electrical laminates being exposed to very different temperature profiles wave soldering and re-work, requiring an increased thermal resistance. As a result of this problem, the industry is converting from DICY to phenolic curing agents. Although the use of phenolic curing agents leads to acceptable thermal resistance, new problems are introduced including brittleness, poor adhesion to copper and glass, and some difficulty in producing laminates within thickness tolerance limits. Brittleness is a particular problem because it leads to rough drill hole surfaces, which in turn causes problems with copper plating, finally leading to board failure.

Therefore, increasing the thermal stability of epoxy resins without having a significant unfavorable impact on other laminate properties would be desirable. One method is to add a metal stabilizer to the epoxy resin. However, the metal stabilizer can settle over time, thereby making storage stability an impediment. A desirable shelf life for an epoxy resin is 12 months, however metal stabilizers can settle in days. This heterogeneity is not desirable from a commercial perspective. Therefore, a way to incorporate a metal stabilizer into an epoxy resin that reduces the amount of settling would be desirable.

### SUMMARY OF THE INVENTION

In an embodiment of the invention there is disclosed a method comprising, consisting of, or consisting essentially of: (a) mixing a stabilizer comprising a metal-containing compound, said metal-containing compound comprising a metal selected from the group consisting of Group 11-13 metals and combinations thereof, into a dispersant to provide a dispersion; and (b) adding said dispersion to a varnish.

### DETAILED DESCRIPTION OF THE INVENTION

In an embodiment of the invention there is disclosed a method comprising, consisting of or consisting essentially of: (a) mixing a stabilizer comprising a metal-containing compound, said metal-containing compound comprising a metal selected from the group consisting of Group 11-13 metals and combinations thereof, into a dispersant to provide a dispersion; and (b) adding said dispersion to a varnish.

Any suitable metal containing compound can be used as a stabilizer in embodiments disclosed herein. Generally, the metal in the metal containing compound is selected from the group consisting of Group 11-13 metals of the Periodic Table of the Elements and combinations thereof. These metals include copper, silver, gold, zinc, cadmium, mercury, boron, aluminum, gallium, indium, and thallium. In addition to Group 11-13 metals, lead and tin can also be used. In an embodiment, the metal is zinc.

In embodiments disclosed herein, the metal containing compound can generally be a metal salt, a metal hydroxide, a metal oxide, a metal acetylacetonate, an organometallic compound, and combinations of any two or more thereof. In an embodiment wherein the metal is zinc, the metal containing compound is selected from the group consisting of a zinc salt, zinc hydroxide, zinc oxide, zinc acetylacetonate, an organic zinc compound and combinations of any two or more thereof. In an embodiment, the metal containing compound can be zinc oxide. In an embodiment, the metal containing compound is zinc dimethyldithiocarbamate (also known as ‘ziram’).

The stabilizer can be generally present in an amount in the range of from about 0.1 weight percent to about 40 weight percent, based on the total weight of the resin formulation.

Any suitable dispersant can be used. Examples include, but are not limited to polyphenols, polyepoxides, anhydrides, and polyamines.

Examples of polyphenols include novolacs such as phenol novolac, cresol novolac, bisphenol A novolac, bisphenols such as bisphenol F (bis(4-hydroxyphenyl)-methane), bisphenol A, tetrabromobisphenol A, and phenolic oligomers that are prepared by condensing an excess of a polyphenol with a diepoxide.

Examples of polyepoxides include glycidyl ethers of the polyphenols listed above, solid epoxy resins which are condensation products of polyphenols with polyepoxides with specific examples being D.E.H.™ series oligomers such as D.E.H.™ 661 and 663 and flow modifiers such as D.E.R.™ 692 and D.E.R.™ 6508. Other examples include bromine-containing epoxies such as tetrabromobisphenol A diglycidyl ether and brominated oligomers such as D.E.R.™ 592, D.E.R.™ 593, D.E.R.™ 539, D.E.R.™ 530, D.E.R.™ 538 D.E.R.™ 514 and D.E.R.™ 560.

Examples of anhydrides include nadic anhydride, hexahydrophthalic anhydride, methyl hexahydrophthalic anhydride, copolymers of maleic anhydride with olefins such as styrene.

Examples of polyamines include dicyandiamide, aromatic amines such as methylene dianiline and toluenediamine, cycloaliphatic amines such as ethanolamine, aminated polyols, ethylene diamine, diethylene triamine and related oligomers, and cycloaliphatic amines such as N-aminoethyl piperazine, isophorone diamine, 1,4-bis(aminomethyl)cyclohexane and isomers.

In an embodiment, high shear mixing can be utilized to mix the stabilizer with the dispersant. These generally comprise a driven vertical shaft and a high shear disk-like blade. The blade creates a radial flow pattern within a stationary mix vessel. The blade creates a vortex that pulls in the contents of the vessel to the blade's sharp edges. The blade's edges then tear apart the solids, reducing their size, and at the same time dispersing the solid particles in the dispersant. These mixers have very high speeds, generally at least 500 rpm.

Another method useful for mixing the stabilizer with the dispersant is by co-extrusion. The stabilizer and the dispersant are added to a powder mixer in order to break the solids into smaller particle sizes. The components are then introduced into an extruder and are co-extruded at a temperature above the glass transition temperature of the epoxy resin, generally between 0° C. and 200° C. The screw speed by which the components are co-extruded is generally between 0 and 500 rpm.

Another method useful for mixing the stabilizer with the dispersant is a ball mill. The stabilizer/dispersant mixture is charged into a vertical column chamber together with a certain amount of glass beads. Under the stirring of two round discs, the glass beads collide and grind each other, generating a strong shearing force which is intended to more efficiently break the solid agglomerates leading to a smaller average particle size of the stabilizer in the final mixture. On an industrial scale, a diaphragm pump is connected to a horizontal mill chamber to more efficiently charge the stabilizer/dispersant mixture, and zirconium oxide coated glass beads with much higher hardness are used to replace the glass beads.

The dispersion can then be added to a varnish. The varnish can then be ready for use without first having to agitate settled solid particles. In addition to an epoxy resin, the varnish can also contain curing agents, hardeners, and catalysts.

The epoxy resin component can be any type of epoxy resin useful in molding compositions, including any material containing one or more reactive oxirane groups, referred to herein as “epoxy groups” or “epoxy functionality.” Epoxy resins useful in embodiments disclosed herein can include mono-functional epoxy resins, multi- or poly-functional epoxy resins, and combinations thereof. Monomeric and polymeric epoxy resins can be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins can also include reactive —OH groups, which can react at higher temperatures with anhydrides, organic acids, amino resins, phenolic resins, or with epoxy groups (when catalyzed) to result in additional crosslinking. In an embodiment, the epoxy resin is produced by contacting a glycidyl ether with a bisphenol compound, such as, for example, bisphenol A or tetrabromobisphenol A to form oxazolidinone moieties.

In general, the epoxy resins can be glycidylated resins, cycloaliphatic resins, epoxidized oils, and so forth. The glycidylated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphenyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin can include glycidyl ether type; glycidyl-ester type; alicyclic type; heterocyclic type, and halogenated epoxy resins, etc. Non-limiting examples of suitable epoxy resins can include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds can include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobispehnol A (2,2-bis(4-(2,3-epoxypropoxy)-3-bromo-phenyl)propane), diglydicylether of bisphenol F (2,2-bis(p-(2,3-epoxypropoxy)phenyl)methane), triglycidyl ether of meta- and/or para-aminophenol (3-(2,3-epoxypropoxy) N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found can be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins can also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidlyamine epoxy resins; and novolac resins.

The epoxy compounds can be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are useful include those based on glycidyl ether monomers. Examples are di- or polyglycidyl ethers of polyhydric phenols obtained by reacting a polyhydric phenol, such as a bisphenol compound with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the trade names D.E.R.™ 530, 539, 542, 560, 592, and 593, available from The Dow Chemical Company, Midland, Mich.); polyglycidyl ether of phenolformaldehyde novolac (such as those available under the tradenames D.E.N.™ 431 and D.E.N.™ 438 available from The Dow Chemical Company, Midland, Mich.); and resorcinol diglycidyl ether. Although not specifically mentioned, other epoxy resins under the tradename designations D.E.R.™ and D.E.N.™ available from The Dow Chemical Company can also be used.

Other suitable epoxy resins are disclosed in, for example, U.S. Pat. Nos. 7,163,973, 6,632,893, 6,242,083, 7,037,958, 6,572,971, 6,153,719, and 5,405,688 and U.S. Patent Application Publication Nos. 20060293172 and 20050171237, each of which is hereby incorporated herein by reference.

Other suitable epoxy resins include phenolic resins, benzoxazine resins, aryl cyanate resins, aryl triazine resins, and a maleimide resins. Mixtures of any of the above-listed epoxy resins may, of course, also be used.

A hardener (or curing agent) can be provided for promoting crosslinking of the curable composition to form a thermoset composition. The hardeners can be used individually or as a mixture of two or more. In some embodiments, hardeners can include dicyandiamide (dicy) or phenolic curing agents such as novolacs, resoles, bisphenols. Other hardeners can include advanced (oligomeric) epoxy resins, some of which are disclosed above. Examples of advanced epoxy resin hardeners can include, for example, epoxy resins prepared from bisphenol A diglycidyl ether (or the diglycidyl ether of tetrabromobisphenol A) and an excess of bisphenol or (tetrabromobisphenol). Anhydrides such as poly(styrene-co-maleic anhydride) can also be used.

Hardeners can also include primary and secondary polyamines and adducts thereof, anhydrides, and polyamides. For example, polyfunctional amines may include aliphatic amine compounds such as diethylene triamine (D.E.H.™ 20, available from The Dow Chemical Company, Midland, Mich.), triethylene tetramine (D.E.H.™ 24, available from The Dow Chemical Company, Midland, Mich.), tetraethylene pentamine (D.E.H.™ 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, can also be used.

Anhydride hardeners can include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener can include a phenol-derived or substituted phenol-derived novolac or an anhydride. Non-limiting examples of suitable hardeners include phenol novolac hardener, cresol novolac hardener, dicyclopentadiene bisphenol hardener, limonene type hardener, anhydrides, and mixtures thereof.

In some embodiments, the phenol novolac hardener can contain a biphenyl or naphthyl moiety. The phenolic hydroxy groups can be attached to the biphenyl or naphthyl moiety of the compound. This type of hardener can be prepared, for example, according to the methods described in EP915118A1. For example, a hardener containing a biphenyl moiety can be prepared by reacting phenol with bismethoxy-methylene biphenyl.

In other embodiments, hardeners may include dicyandiamide, boron trifluoride monoethylamine, and diaminocyclohexane. Hardeners may also include imidazoles, their salts, and adducts. These epoxy hardeners are typically solid at room temperature. Examples of suitable imidazole hardeners are disclosed in EP906927A1. Other hardeners include phenolic, benzoxazine, aromatic amines, amido amines, aliphatic amines, anhydrides, and phenols.

In some embodiments, the hardeners may be polyamides or an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of hardeners useful in embodiments disclosed herein include: 3,3′- and 4,4′-diaminodiphenylsulfone; methylenedianiline; bis(4-amino-3,5-dimethyl-phenyl)-1,4-diisopropylbenzene available as EPON 1062 from Hexion Chemical Co.; and bis(4-aminophenyl)-1,4-diisopropylbenzene available as EPON 1061 from Hexion Chemical Co.

Thiol hardeners for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetrakismercaptobenzene, bis-, tris- or tetrakis (mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetrakis (mercaptoalkylthio)benzene, bis-, tris- or tetrakis (mercaptoalkylthio)alkane, bis(mercaptoalkyl) disulfide, hydroxyalkylsulfide bis(mercaptopropionate), hydroxyalkylsulfide bis(mercaptoacetate), mercaptoethyl ether bis(mercaptopropionate), 1,4-dithian-2,5-diol bis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The hardener can also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or methacrylates may also be utilized as curing agents. In addition, various Mannich bases can be used. Aromatic amines wherein the amine groups are directly attached to the aromatic ring may also be used.

Quaternary ammonium salts with a nucleophilic anion useful as a hardener in embodiments disclosed herein can include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium isocyanate, N-methylpyrridinium phenolate, N-methyl-o-chloropyrridinium chloride, methyl viologen dichloride and the like.

The suitability of the hardener for use herein can be determined by reference to manufacturer specifications or routine experimentation. Manufacturer specifications can be used to determine if the curing agent is an amorphous solid or a crystalline solid at the desired temperatures for mixing with the liquid or solid epoxy. Alternatively, the solid curing agent can be tested using differential scanning calorimetry (DSC) to determine the amorphous or crystalline nature of the solid curing agent and the suitability of the curing agent for mixing with the resin composition in either liquid or solid form.

Mixtures of one or more of the above described epoxy hardeners (or curing agents) can also be used.

Optionally, catalysts can be added to the varnishes described above. Catalysts can include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzyl imidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts can include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Non-amine catalysts can also be used. Organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, may be used. Illustrative examples include bismuth nitrate, lead 2-ethylhexoate, lead benzoate, ferric chloride, antimony trichloride, stannous acetate, stannous octoate, and stannous 2-ethylhexoate. Other catalysts that can be used are disclosed in, for example, PCT Publication No. WO 00/15690, which is incorporated by reference in its entirety.

In some embodiments, suitable catalysts can include nucleophilic amines and phosphines, especially nitrogen heterocycles such as alkylated imidazoles: 2-phenyl imidazole, 2-methyl imidazole, 1-methyl imidazole, 2-methyl-4-ethyl imidazole; other heterocycles such as diazabicycloundecene (DBU), diazabicyclooctene, hexamethylenetetramine, morpholine, piperidine; trialkylamines such as triethylamine, trimethylamine, benzyldimethyl amine; phosphines such as triphenylphosphine, tritolylphosphine, triethylphosphine; quaternary salts such as triethylammonium chloride, tetraethylammonium chloride, tetraethylammonium acetate, triphenylphosphonium acetate, and triphenylphosphonium iodide. Mixtures of one or more of the above described catalysts can also be used.

In an embodiment, a solvent can also be added to the varnish. Suitable solvents include but are not limited to water and organic solvents with boiling points below 200° C. Examples of these solvents include acetone, 2-butanone, methyl isobutyl ketone, cyclohexanone, methanol, ethanol, isopropanol, n-butanol and isobutanol, methoxy propanols (ie. Dowanol™ PM), methoxypropyl acetates (Dowanol™ PMA), and N,N′-dimethyl formamide.

It can be advantageous to use metal stabilizers that have been surface-treated to aid in the dispersion process. Such surface treatments allow the particles to be separated with relative ease, and reduce the tendency to re-agglomerate. Examples of surface treatments include carboxylic acids, sulfonic and sulfuric acids, phosphoric and phosphonic acids and related surfactants. Specific examples are aliphatic carboxylic acids such as acetic, oleic, and stearic acid, phenyl sulfonic acid, toluene sulfonic acid, sulfate esters of long-chain alcohols. Other treatments include silanes and silicones.

Such treatments are designed to change the surface characteristics of the solid, typically by forming an inert surface layer. Alternately, treatments that are designed to coat the surface and interact with the components of the present invention are possible. Specific examples are aminopropyl trimethoxysilanes, epoxy silanes, methacryloxy propyl trimethoxy silane.

Dispersing aids that are added to the formulation are well known in the art. A large number of proprietary additives, for example from BYK, are available.

In some embodiments, fillers can be used. Suitable fillers can include, for example, silica, alumina, glass, talc, metal powders, titanium dioxide, wetting agents, pigments, coloring agents, mold release agents, coupling agents, ion scavengers, UV stabilizers, flexibilizing agents, and tackifying agents. Additives and fillers can also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers can include functional or non-functional particulate fillers that may have a particle size ranging from 0.5 nm to 100 microns and may include, for example, alumina trihydrate, aluminum oxide, aluminum hydroxide oxide, metal oxides, and nano tubes). Fillers and modifiers can be preheated to drive off moisture prior to addition to the epoxy resin composition. Additionally, these optional additives can have an effect on the properties of the composition, before and/or after curing, and should be taken into account when formulating the varnish and the desired reaction product. Silane treated fillers can be used.

In other embodiments, varnishes disclosed herein can also include nanofillers. Nanofillers can be inorganic, organic, or metallic, and can be in the form of powders, whiskers, fibers, plates or films. The nanofillers can be generally any filler or combination of fillers having at least one dimension (length, width, or thickness) from about 0.1 to about 100 nanometers. For example, for powders, the at least one dimension may be characterized as the grain size; for whiskers and fibers, the at least one dimension is the diameter; and for plates and films, the at least one dimension is the thickness. Clays, for example, may be dispersed in an epoxy resin-based matrix, and the clays may be broken down into very thin constituent layers when dispersed in the epoxy resin under shear. Nanofillers may include clays, organo-clays, carbon nanotubes, nanowhiskers (such as SiC), SiO₂, elements, anions, or salts of one or more elements selected from the s, p, d, and f groups of the periodic table, metals, metal oxides, and ceramics.

In some embodiments, composites can be formed by curing the varnishes disclosed herein. In other embodiments, composites may be formed by applying a curable epoxy resin composition to a substrate or a reinforcing material, such as by impregnating or coating the substrate or reinforcing material to form a prepreg, and curing the prepreg under pressure to form the electrical laminate composition.

After the varnish has been produced, as described above, it can be disposed on, in, or between the above described substrates, before, during, or after cure of an electrical laminate composition. For example, a composite may be formed by coating a substrate with a varnish. Coating may be performed by various procedures, including spray coating, curtain flow coating, coating with a roll coater or a gravure coater, brush coating, and dipping or immersion coating.

In various embodiments, the substrate can be monolayer or multi-layer. For example, the substrate may be a composite of two alloys, a multi-layered polymeric article, and a metal-coated polymer, among others, for example. In other various embodiments, one or more layers of the curable composition may be disposed on a substrate. Other multi-layer composites, formed by various combinations of substrate layers and electrical laminate composition layers are also envisaged herein.

In some embodiments, the heating of the varnish can be localized, such as to avoid overheating of a temperature-sensitive substrate, for example. In other embodiments, the heating may include heating the substrate and the composition.

Curing of the varnishes disclosed herein may require a temperature of at least about 30° C., up to about 250° C., for periods of minutes up to hours, depending on the epoxy resin, hardener, and catalyst, if used. In other embodiments, curing can occur at a temperature of at least 100° C., for periods of minutes up to hours. Post-treatments may be used as well, such post-treatments ordinarily being at temperatures between about 100° C. and 250° C.

In some embodiments, curing can be staged to prevent exotherms. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures can range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

The varnishes disclosed herein may be useful in composites containing high strength filaments or fibers such as carbon (graphite), glass, boron, and the like. Composites can contain from about 30% to about 70%, in some embodiments, and from 40% to 70% in other embodiments, of these fibers based on the total volume of the composite.

Fiber reinforced composites, for example, can be formed by hot melt prepregging. The prepregging method is characterized by impregnating bands or fabrics of continuous fiber with a thermosetting composition as described herein in molten form to yield a prepreg, which is laid up and cured to provide a composite of fiber and epoxy resin.

Other processing techniques can be used to form electrical laminate composites containing the compositions disclosed herein. For example, filament winding, solvent prepreging, and pultrusion are typical processing techniques in which the varnish may be used. Moreover, fibers in the form of bundles can be coated with the varnish, laid up as by filament winding, and cured to form a composite.

The varnishes and composites described herein may be useful as adhesives, structural and electrical laminates, coatings, marine coatings, composites, powder coatings, adhesives, castings, structures for the aerospace industry, and as circuit boards and the like for the electronics industry.

In some embodiments, the varnish can be used in composites, coatings, adhesives, or sealants that may be disposed on, in, or between various substrates. In other embodiments, the varnishes may be applied to a substrate to obtain an epoxy based prepreg. As used herein, the substrates include, for example, glass cloth, a glass fiber, glass paper, paper, and similar substrates of polyethylene and polypropylene. The obtained prepreg can be cut into a desired size. An electrical conductive layer can be formed on the laminate/prepreg with an electrical conductive material. As used herein, suitable electrical conductive materials include electrical conductive metals such as copper, gold, silver, platinum and aluminum. Such electrical laminates may be used, for example, as multi-layer printed circuit boards for electrical or electronics equipment. Laminates made from the maleimide-triazine-epoxy polymer blends are especially useful for the production of HDI (high density interconnect) boards. Examples of HDI boards include those used in cell phones or those used for Interconnect (IC) substrates.

### EXAMPLES

The following examples are intended to be illustrative of the present invention and to teach one of ordinary skill in the art to make and use the invention. The examples are not intended to limit the invention in any way.

In the following examples, the components are as follows:

D.E.R.™ 530-A80: brominated epoxy prepared by condensing an excess of bisphenol A diglycidyl ether with tetrabromobisphenol A (80% solids in acetone)

D.E.R.™ 592-A80: brominated epoxy prepared by condensing an excess of bisphenol A diglycidyl ether with methylene diisocyanate and tetrabromobisphenol A (80% solids in acetone)

D.E.R.™ 383: Diglycidyl ether of bisphenol A

D.E.N.™ 438EK85 is a novolac prepared via condensation polymerization of acetone and phenol (85% solids in MEK)

Nano-ZnO is a zinc oxide from Aldrich with an average particle size of less than 1 μm

NanoTek™ ZnO is a zinc oxide from Nanophase Technologies with an average particle size of less than 100 nm

NanoGard™ ZnO is a zinc oxide from Nanophase Technologies with an average particle size of less than 100 nm

Zn(acac)₂ is zinc acetoacetonate from Aldrich

MEK is methyl ethyl ketone from Aldrich

In the below examples, 4 masterbatches were dispersed using a high shear mixer.

### Example 1

A 50 gram quantity of D.E.R.™ 530-A80 and a 17.15 gram quantity of Nano-ZnO were dispersed in a high shear mixer. The high shear mixer operated at 3000-5000 rpm with heat release. A 30 mL quantity of MEK was added to adjust viscosity. The mixture became fluid. With 20 mL of MEK, the mixture was a paste which did not flow. The weight percent of the stabilizer was 30.01 wt % (vs total solids). The total solids weight percent was 62.70%.

### Example 2

A 50 gram quantity of D.E.R.™ 530-A80 and a 17.15 gram quantity of Zn(acac)₂ were dispersed in a high shear mixer. The high shear mixer operated at 3000-5000 rpm with heat release. No additional solvent was added, resulting in a mixture which was a paste that flowed slowly. The weight percent of the stabilizer was 30.01 wt % (vs total solids). The total solids weight percent was 85.11%.

### Example 3

A 50 gram quantity of D.E.R.™ 592-A80 and a 17.15 gram quantity of Nano-ZnO were dispersed in a high shear mixer. The high shear mixer operated at 3000-5000 rpm with heat release. A 20 mL quantity of MEK was added to adjust the viscosity. The mixture was a fluid-paste. The weight percent of the stabilizer was 30.01 wt % (vs total solids). The total solids weight percent was 68.73%.

### Example 4

A 25 gram quantity of D.E.R.™ 530-A80 and a 8.57 gram quantity of Zn(acac)₂ were dispersed in a high shear mixer. The high shear mixer operated at 3000-5000 rpm with intense heat release resulting in a highly viscous paste. A 10 mL quantity of MEK was added, but the mixture had to be shaked to achieve a homogeneous paste. The weight percent of the stabilizer was 30.00 wt % (vs total solids). The total solids weight percent was 85.11%.

### Examples 5-12

Examples 5-12 are detailed in Table I, below.

TABLE I
Dispersions prepared via high shear mixing

| | Example | | | | | | | |
|---|---|---|---|---|---|---|---|---|
| | 5 | 6 | 7 | 8 | 9 | 10 | 11 | 12 |
| D.E.R. ™ 383 (g) | 95 | 90 | 85 | 80 | 75 | | | |
| D.E.N ™ 438EK85 (g) | | | | | | 90 | 85 | 80 |
| NanoTek ZnO (g) | 5 | 10 | 15 | 20 | 25 | 10 | 15 | 20 |
| Stabilizer wt % (vs total | 5.0% | 10% | 15% | 20% | 25% | 13.1% | 17.2% | 29.4% |
| solids) | | | | | | | | |
| Total solids wt % | 100% | 100% | 100% | 100% | 100% | 86.5% | 87.3% | 88.0% |
| Viscosity by cone-plate | 10.22 | 11.48 | 13.14 | 15.47 | 18.90 | 2.35 | 2.60 | 2.99 |
| (Pa/s) | | | | | | | | |

| | | |
|---|---|---|
| Notes | High shear of between | High shear of between |
| | 2000 to 5000 rpm for a period | 2000 to 5000 rpm for a period |
| | of between 5 to 20 minutes. | of between 5 to 20 minutes. |
| | Heat release observed. | Heat release observed. |
| | | No solvent added |

### Example 13

A solid masterbatch was prepared by co-extrusion as detailed in Table II, below. Neat D.E.R.™ 592 and ZnO are weighed into a 2 gallon plastic bucket. This mixture was then blended in a Prism mixer at 2300 rpm for 15 seconds at a constant temperature of 26° C. This blending process was repeated twice more. The powdery mixture is then introduced into a twin screw extruder (Prism TSE-24-PC Powder Coating Extruder) operating at 400 rpm screw speed. The extruder was equipped with three heating zones set at 25° C., 75° C., 90° C. and the resulting off-white solid was flaked with a small drum flaker.

TABLE II
Solid masterbatch prepared by co-extrusion

| | Example 13 |
|---|---|
| D.E.R. ™ 592 (neat) (g) | 1224 |
| NanoTek ZnO (g) | 306 |
| Stabilizer wt % (vs total solids) | 20% |
| Total solids wt % | 100% |
| Viscosity@150 C. by cone-plate (Pa/s) | 1.18 |

### Example 14

In this example, a dispersion was prepared by adding pre-dispersed zinc oxide dropwise to an epoxy resin and was then agitated with gentle shaking for one hour. This is detailed in Table III, below.

TABLE III
Dispersion prepared with pre-dispersed stabilizer

| | |
|---|---|
| D.E.R. ™ 592A80 (g) | 6.375 |
| NanoTek ™ ZnO (dispersed in | 0.102 |
| Dowanol ™ PMA) (g) | |
| Stabilizer % solids | 50.0% |
| Stabilizer wt % (vs total solids) | 1.0% |
| Total solids wt % | 79.53% |
| Viscosity@150 C. by cone-plate (Pa/s) | n/d |

### Example 16

A dispersion was prepared via ball mill mixing. Raw materials and glass beads were agitated in a 2 L ball mill at 2800 rpm for 30 minutes with cooling water circulating in the jacket. The glass beads were then removed by a filter installed near the bottom of the canister. The amounts of components in the dispersion are detailed in Table IV below.

TABLE IV
Dispersion prepared via ball mill mixing

| | |
|---|---|
| D.E.R. ™ 530A80 (g) | 875 |
| Nano ZnO (average particle size | 300 |
| ~68 nm) (g) | |
| Stabilizer wt % (vs total solids) | 30.0% |
| Total solids wt % | 85.1% |
| Viscosity@150 C. by cone-plate (Pa/s) | n/d |

While this invention has been described in detail for the purpose of illustration, it should not be construed as limited thereby but intended to cover all changes and modifications within the spirit and scope thereof.

That which claimed is:

1. A method comprising:
(a) mixing a stabilizer comprising a metal-containing compound, said metal-containing compound comprising a metal selected from the group consisting of Group 11-13 metals and combinations thereof, into a dispersant to provide a dispersion;
(b) adding said dispersion to a varnish.

2. A method in accordance with claim 1 wherein said mixing is high shear mixing.

3. A method in accordance with claim 2 wherein the rate of said high shear mixing is at least 500 rpm.

4. A method in accordance with claim 1 wherein said mixing is ball mill mixing.

5. A method in accordance with claim 1 wherein said mixing is in a powder mixer, followed by co-extrusion.

6. A method in accordance with claim 1 wherein the time period for said mixing is at least 30 seconds.

7. A method in accordance with claim 1 wherein said dispersant is selected from the group consisting of a polyphenol, a polyepoxide, an anhydride, a polyamine, and combinations thereof.

8. A method in accordance with claim 1 wherein said metal is zinc.

9. A method in accordance with claim 8 wherein said metal containing compound is selected from the group consisting of a zinc salt, zinc hydroxide, zinc oxide, zinc acetylacetonate, an organic zinc compound and combinations of any two or more thereof.

10. A method in accordance with claim 1 wherein said varnish further comprises a component selected from the group consisting of an inert filler, a solvent, and mixtures thereof.

11. A method in accordance with claim 1 wherein said stabilizer is present in said dispersion in a range of from about 5 to about 75 weight percent, based on the total weight of the dispersion.

12. A varnish produced by the method of claim 1.

13. A prepreg prepared from the varnish of claim 12.

14. An electrical laminate prepared from the varnish of claim 12.

15. A coating prepared from the varnish of claim 12.

16. A composite prepared from the varnish of claim 12.

17. A casting prepared from the varnish of claim 12.

18. An adhesive prepared from the varnish of claim 12.
